(19) United States
(12) Patent Application Publication
(10) Pub. No.: US 2025/0086365 A1
(43) Pub. Date: Mar. 13, 2025

(54) METHOD FOR DESIGNING SUPERCRITICAL HEAT EXCHANGER BASED ON PSEUDO-PHASE TRANSITION PARTITION

(71) Applicant: Kunming University of Science and Technology, Kunming (CN)

(72) Inventors: Zhouhang Li, Kunming (CN); Genxian Yang, Kunming (CN); Yuling Zhai, Kunming (CN); Hua Wang, Kunming (CN)

(21) Appl. No.: 18/955,880

(22) Filed: Nov. 21, 2024

(30) Foreign Application Priority Data
Dec. 21, 2023 (CN) 202311765652.X

(51) Int. Cl. G06F 30/28; G06F 113/08; G06F 119/08

(52) U.S. Cl. CPC G06F 30/28; G06F 2113/08; G06F 2119/08

(57) ABSTRACT

The present disclosure provides a method for designing a supercritical heat exchanger based on pseudo-phase transition partition. The method mainly includes the following steps: inputting boundary conditions of a heat exchanger; calculating an upper boundary temperature and a lower boundary temperature of a pseudo-phase transition region; calculating a temperature of an inner wall surface of a supercritical fluid; determining an upper boundary temperature of a pseudo-superheated condensation region; and dividing the heat exchanger into four sections on the basis of above three boundary temperatures and inlet and outlet temperatures, and calculating the section size and the total size of the heat exchanger. According to the method, the automatic partition determination of single-phase cooling and pseudo-superheated condensation in a supercritical air cooler can be realized, requiring no division of the heat exchanger according to equal enthalpy change or equal length, and the calculation is rapid and accurate.

### CROSS-REFERENCE TO RELATED APPLICATION

This application claims priority of Chinese Patent Application No. 202311765652.X, filed on Dec. 21, 2023, the entire contents of which are incorporated herein by reference.

### TECHNICAL FIELD

The present disclosure relates to the technical field of heat exchangers, and in particular to a method for designing a supercritical heat exchanger based on pseudo-phase transition partition.

### BACKGROUND

Due to the dramatic changes in the thermophysical properties of supercritical fluid in the pseudo-critical region and the absence of isothermal phase change in the heat absorption and exothermic process, the application of supercritical fluid in power system or energy conversion system can improve the thermal efficiency and exergy efficiency of the system, making the research on heat exchange of supercritical fluid being one of the hotspots currently. Relevant studies have shown that when the temperature of supercritical fluid is lower than the pseudo-critical temperature (Tpc), the thermophysical properties of the fluid are closer to those of liquid fluid, showing high density and high thermal conductivity. When the temperature of supercritical fluid is higher than Tpc, the thermophysical properties of the fluid show obvious “gas-like” characteristics, including low viscosity and high diffusion coefficient. In the pseudo-critical region, the change trend of density, viscosity and other parameters of supercritical fluid is similar to that in boiling/condensation process under subcritical state. In addition, near Tpc, the specific heat capacity of supercritical fluid increases sharply, which is macroscopically manifested as a gentle change trend of its temperature distribution curve. This phenomenon can also be compared to the situation under subcritical pressure, where when the temperature reaches the boiling point, the temperature of the fluid remains unchanged in the absorption/exothermic process, and at this time, the specific heat capacity of the fluid increases to infinity. In summary, the heat exchange phenomenon of supercritical fluid in pseudo-critical region is similar to the phase transition under subcritical pressure.

As early as 1960-1970, scholars put forward the pseudo-boiling hypothesis based on this similarity, pointing out that the thermodynamic state of supercritical fluid can be divided into three regions according to the thermophysical properties: liquid-like region, pseudo-two-phase region and gas-like region. Subsequently, some scholars have observed through experiments that bubbles are generated in the process of heating fluid near the critical pressure. proving the feasibility of pseudo-boiling hypothesis to some extent. In 2015, Banuti further pointed out that pseudo-boiling/pseudo-phase transition is a continuous nonlinear process, and proposed a quantitative analysis method to accurately determine the boundary of the pseudo-two-phase region. Pseudo-boiling theory has been used in the research of supercritical heat exchange, and some scholars have applied this theory to accurately predict the heat transfer deterioration in supercritical straight tubes.

As one of the important components in transcritical or supercritical system, heat exchanger greatly affects the efficiency and initial investment of the system. Therefore, the accurate design of heat exchanger is very important to evaluate the economic performance of the system. However, the distribution of temperature and physical properties show nonlinear changes under supercritical pressure, and the traditional method of the design of heat exchanger or evaluation of heat transfer performance using the average parameter of inlet and outlet has large errors and less guidance. Accordingly, the traditional method is no longer suitable for supercritical heat exchangers. To solve this problem, scholars usually use the method based on equal enthalpy change or equal length to discretize the heat exchanger into several sections for calculation. Compared with the traditional method, the calculation time of this method is greatly increased. In 2022, based on the pseudo-phase transition theory, Peeters et al. attempted to divide the heat exchanger into three sections and design separately, but obtained an undesired calculation accuracy. To improve the accuracy, they artificially added two additional segmentation points, T⁺⁺ and T⁻⁻, and divided the heat exchanger into five sections for calculation, which effectively improved the accuracy [Peeters J W R. On the effect of pseudo-condensation on the design and performance of supercritical CO₂ gas chillers. International Journal of Heat and Mass Transfer, 2022, 186: 122441]. However, T⁺⁺ and T⁻⁻ are artificially set in this study, and neither are provided with selection basis, which brings difficulties and uncertainties to the design of heat exchangers under different working conditions.

### SUMMARY

### I. Technical Problems to Be Solved

In response to the shortcomings existing in the prior art, the present disclosure provides a method for designing a supercritical heat exchanger based on pseudo-phase transition partition, which has the advantages of ensuring the accuracy of the heat exchanger design in a wide range of working conditions while reducing computational resources, thereby solving the technical problems above described.

### II. Technical Solutions

To achieve the above objective, the present disclosure provides the following technical solutions. A method for designing a supercritical heat exchanger based on pseudo-phase transition partition includes the following steps:
S1, inputting boundary conditions of a heat exchanger;
S2, calculating an upper boundary temperature and a lower boundary temperature of a pseudo-phase transition region;
S3, calculating a temperature of an inner wall surface of a first fluid in the heat exchanger, and determining an upper boundary temperature of a pseudo-superheated condensation region during cooling the first fluid or an upper boundary temperature of a pseudo-subcooled boiling region during heating the first fluid;
S4, dividing the heat exchanger into four regions on the basis of a pseudo-phase transition three-region model, and calculating a length of the heat exchanger in each region; and
S5, obtaining a total length of the heat exchanger.

In a preferred technical solution of the present disclosure, the boundary conditions in S1 include boundary conditions and thermophysical information of the first fluid and the second fluid, the first fluid is supercritical fluid and the second fluid is ordinary fluid, and the boundary conditions include mass flow rate, inlet and outlet temperatures, pressure, inner diameter and wall thickness of inner tube and inner diameter of outer tube of a casing, and the thermophysical information includes dynamic viscosity, enthalpy, specific heat capacity and Prandtl number.

In a preferred technical solution of the present disclosure, the boundary temperature of the pseudo-phase transition region in S2 includes boundary temperatures Tₚ⁻ and Tₚ⁺ of the first fluid, and boundary temperatures Tₛ⁻ and Tₛ⁺ of the second fluid.

In a preferred technical solution of the present disclosure, the boundary temperatures Tₚ⁻ and Tₚ⁺ of the first fluid are calculated, and expressions for solving a gas-like region, a pseudo-two-phase region and a liquid-like region are as follows:

$$\begin{matrix}{h}_{L L} ( T ) = {c}_{p , L L} ( T - {T}_{LL , ref} ) + h ( {T}_{LL , ref} ) \\ {h}_{p b} ( T ) = {c}_{p , p c} ( T - {T}_{p c} ) + h ( {T}_{p c} ) \\ {h}_{GL} ( T ) = {c}_{p , GL} ( T - {T}_{GL , ref} ) + h ( {T}_{GL , ref} )\end{matrix}$$

where h_{LL}(T) represents a function of a liquid-like enthalpy h with respect to a temperature T, c_{p,LL} represents a liquid-like specific heat capacity, T_{LL,ref} represents a temperature of liquid-like reference point, h_{pb}(T) represents a function of pseudo-two-phase enthalpy h with respect to the temperature T, c_{p,pc} represents a pseudo-two-phase specific heat capacity, T_{pc} represents a pseudo-critical temperature, h_{GL}(T) represents a function of gas-like enthalpy h with respect to the temperature T, c_{p,GL} represents a gas-like specific heat capacity, T_{GL,ref} represents a temperature of gas-like reference point, and the unit of all the above temperatures is K.

In a preferred technical solution of the present disclosure, the boundary temperatures Tₛ⁻ and Tₛ⁺ of the second fluid are calculated, and expressions of the heat balance equations of the fluid on two sides of the gas-like region and the liquid-like region are as follows:

$$\begin{matrix}{m}_{p} ( {h}_{p}^{i n} - {h}_{p}^{+} ) = {m}_{s} ( {h}_{s}^{out} - {h}_{s}^{+} ) \\ {m}_{p} ( {h}_{p}^{i n} - {h}_{p}^{-} ) = {m}_{s} ( {h}_{s}^{out} - {h}_{s}^{-} )\end{matrix}$$

where mₚ represents a mass flow rate of the first fluid, mₛ represents a mass flow rate of the second fluid, hₚⁱⁿ represents an enthalpy value at the inlet of the first fluid, hₛ^{out} represents an enthalpy value at the outlet of the second fluid, hₚ⁺ represents an enthalpy value at the lower boundary of a pseudo-two-phase region of the first fluid, hₚ⁻ represents an enthalpy value at the upper boundary of the pseudo-two-phase region of the first fluid, hₛ⁺ represents an enthalpy value at the lower boundary of a pseudo-two-phase region of the second fluid, hₛ⁻ represents an enthalpy value at the upper boundary of the pseudo-two-phase region of the second fluid, a subscript p represents the first fluid, and a subscript s represents the second fluid.

In a preferred technical solution of the present disclosure, in S3, the calculating a temperature of an inner wall surface of a first fluid includes calculating an inlet wall temperature T_{w}ⁱⁿ, a wall temperature T_{w} at the upper boundary of the pseudo-two-phase region, a wall temperature T_{w}⁺ at the lower boundary of the pseudo-two-phase region, and an outlet wall temperature T_{w}^{out} at four axial positions corresponding to an inlet temperature Tₛⁱⁿ of a second fluid, a boundary temperature Tₛ⁻ of the second fluid, a boundary temperature Tₛ⁻ of the second fluid and an outlet temperature Tₛ^{out} of the second fluid.

In a preferred technical solution of the present disclosure, equations for calculating the upper boundary temperature Tₚ⁺⁺ of the pseudo-superheated condensation region during cooling the first fluid in step S3 are as follows:

$$\begin{matrix}\frac{{Q}^{+} - {Q}^{++}}{{Q}^{+}} = \frac{{T}_{w}^{++} - {T}_{w}^{+}}{{T}_{w , i n} - {T}_{w}^{+}} \\ {Q}^{++} = {m}_{p} ( {h}_{p}^{i n} - {h}_{p}^{++} )\end{matrix}$$

where Q⁺⁺ is a heat transfer amount from an inlet to the upper boundary of the pseudo-superheated condensation region, hₚ⁺⁺ is an enthalpy value at the upper boundary of the pseudo-superheated condensation region, T_{w}⁺⁺ is a wall temperature at the upper boundary of the pseudo-superheated condensation region, T_{w,in} is a wall temperature at an inlet, mₚ is a mass flow rate of the first fluid, Q⁺ is a heat transfer amount from the inlet to a lower boundary of the pseudo-superheated condensation region, hₚⁱⁿ is an enthalpy value at an inlet of the first fluid, and T_{w}⁺ is a wall temperature at the lower boundary of the pseudo-superheated condensation region.

In a preferred technical solution of the present disclosure, in S4, steps of calculating a length of the heat exchanger in each region are as follows:
S4.1, calculating a heat transfer coefficient Uᵢ of each region;
S4.2, determining the heat exchanger efficiency εᵢ of each region from the inlet and outlet temperatures of hot and cold fluids of the region; and
S4.3, calculating the length Lᵢ of the heat exchanger in the region.

In a preferred technical solution of the present disclosure, an expression of the heat transfer coefficient Uᵢ in S4.1 is as follows:

$${U}_{i} = \frac{N {U}_{i} {λ}_{i}}{d}$$

where Nuᵢ is calculated by empirical correlations,
dis a hydraulic diameter, λᵢ is a thermal conductivity coefficient of an iₜₕ section, and Nuᵢ is the Nusselt number of the iₜₕ section.

In a preferred technical solution of the present disclosure, an expression of the heat exchanger efficiency εᵢ in S4.2 is as follows:

$$\begin{matrix}{ε}_{i} = ( \frac{{\overline{C}}_{p , i}}{{C}_{m i n , i}} ) \frac{{T}_{p , i}^{i n} - {T}_{p , i}^{out}}{{T}_{p , i}^{i n} - {T}_{p , i}^{out}} \\ {\overline{C}}_{p , i} = {m}_{p} \frac{{h}_{p , i}^{out} - {h}_{p , i}^{i n}}{{T}_{p , i}^{out} - {T}_{p , i}^{i n}}\end{matrix}$$

where [symbol] _{p,i} represents an average heat capacity rate of the first fluid in the iₜₕ section, T_{p,i}ⁱⁿ represents a temperature of the first fluid at an inlet of the iₜₕ section, T_{p,i}^{out} represents a temperature of the first fluid at an outlet of the iₜₕ section, mₚ represents a mass flow rate of the first fluid, T_{s,i}ⁱⁿ represents a temperature of the second fluid at an inlet of the iₜₕ section, h_{p,i}^{out} represents an enthalpy value at an outlet of the first fluid, h_{p,i}ⁱⁿ represents an enthalpy value at an inlet of the first fluid, and C_{min,i} represents the minimum heat capacity rate of the iₜₕ section. An expression of the length of the heat exchanger Lᵢ of the region is as follows:

$$\begin{matrix}{L}_{i} = \frac{{C}_{m i n , i}}{{U}_{i} P ( 1 - {R}_{C , i} )} ln \{ \frac{1 - {ε}_{i} {R}_{C , i}}{1 - {ε}_{i}} \} \\ {R}_{C} = \frac{{C}_{m i n}}{{C}_{m ax}}\end{matrix}$$

where R_{C} represents a hot-melt ratio, P represents a wetted perimeter, Cₘₐₓ represents the maximum heat capacity rate, ln represents a logarithmic operation, and a subscript i=I, II, IIIa, IIIb or Ia, Ib, II, III or I, II, III, representing different regions.

In a preferred technical solution of the present disclosure, an expression of the total length of the heat exchanger is as follows:

$${L}_{total} = \{ \begin{matrix}\begin{matrix}{L}_{I} + {L}_{II} + {L}_{IIIa} + {L}_{IIIb} , & cooling of the first fluid\end{matrix} \\ \begin{matrix}{L}_{Ia} + {L}_{Ib} + {L}_{II} + {L}_{III} , & heating of the first fluid\end{matrix} \\ \begin{matrix}{L}_{I} + {L}_{II} + {L}_{III} , & in the absence of {T}_{p}^{++} or {T}_{p}^{-}\end{matrix}\end{matrix}$$

where L is the length of the heat exchanger, Lₜₒₜₐₗ represents the total length of the heat exchanger, Tₚ⁺⁺ represents the upper boundary temperature of the pseudo-superheated condensation region of the first fluid, and Tₚ⁻⁻ represents the upper boundary temperature of the pseudo-subcooled boiling region of the first fluid.

Compared with the prior art, the present disclosure provides a method for designing a supercritical heat exchanger based on pseudo-phase transition partition, which has the following beneficial effects.

According to the present disclosure, the automatic partition determination of single-phase cooling and pseudo-superheated condensation in a supercritical air cooler can be realized, requiring no division of heat exchanger according to equal enthalpy change or equal length, and overcoming the deficiencies of long time consumption and large uncertainty in the existing methods. The method of the present disclosure is suitable for the design and performance checking of various supercritical evaporators and coolers, and has rapid and accurate calculation.

### BRIEF DESCRIPTION OF THE DRAWINGS

FIG. 1 is a schematic diagram for defining T⁻ and T⁺ according to the present disclosure;

FIG. 2 is a schematic diagram for defining T⁺⁺ according to the present disclosure;

FIG. 3 is a schematic diagram showing the delineation of four regions according to the present disclosure;

FIG. 4 is a schematic diagram showing the partition of an air cooler according to the present disclosure;

FIG. 5 is a schematic diagram showing calculation results of a calculation example for an air cooler according to the present disclosure;

FIG. 6 is a schematic diagram showing the partition of an evaporator according to the present disclosure;

FIG. 7 is a schematic diagram showing calculation results of a calculation example for an evaporator calculation according to the present disclosure; and

FIG. 8 is a flow diagram according to the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. On the basis of the examples in the present disclosure, all other examples obtained by those ordinary skilled in the art without creative efforts belong to the scope of protection of the present disclosure.

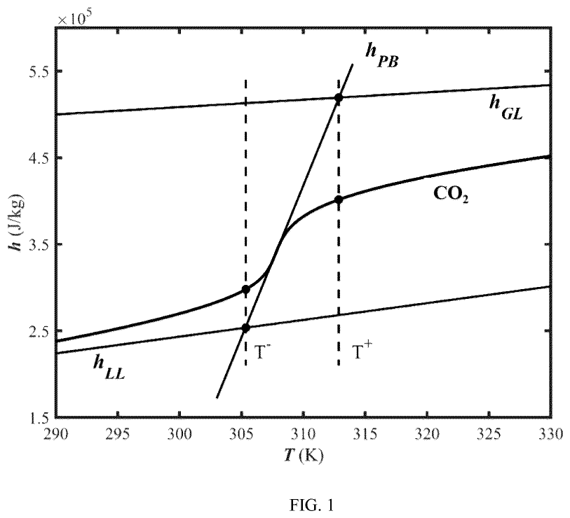

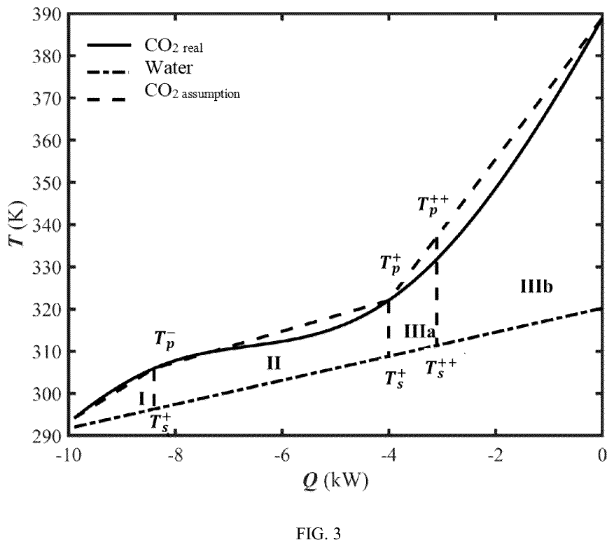

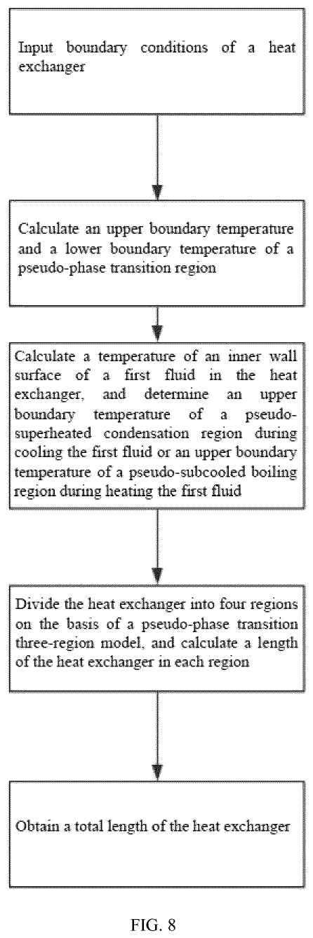

Referring to FIGS. 1-8, a method for designing a supercritical heat exchanger based on pseudo-phase transition partition includes the following steps.

S1, boundary conditions of a heat exchanger are input. The boundary conditions include boundary conditions and thermophysical information of a first fluid and a second fluid. The boundary conditions of the first fluid and the second fluid include mass flow rate, inlet and outlet temperatures, pressure, inner diameter and wall thickness of inner tube, and inner diameter of outer tube of a casing. The thermophysical information includes dynamic viscosity, enthalpy, specific heat capacity, and Prandtl number.

S2, an upper boundary temperature and a lower boundary temperature of the pseudo-phase transition region are calculated. Boundary temperatures of the pseudo-phase transition region include boundary temperatures Tₚ⁻ and Tₚ⁺ of the first fluid, and boundary temperatures Tₛ⁻ and Tₛ⁺ of the second fluid.

The boundary temperatures Tₚ⁻ and Tₚ⁺ of the first fluid are calculated, and expressions for solving a gas-like region, a pseudo-two-phase region and a liquid-like region in parallel are as follows:

$$\begin{matrix}{h}_{L L} ( T ) = {c}_{p , L L} ( T - {T}_{LL , ref} ) + h ( {T}_{LL , ref} ) \\ {h}_{p b} ( T ) = {c}_{p , p c} ( T - {T}_{p c} ) + h ( {T}_{p c} ) \\ {h}_{GL} ( T ) = {c}_{p , GL} ( T - {T}_{GL , ref} ) + h ( {T}_{GL , ref} )\end{matrix}$$

where h_{LL}(T) represents a function of a liquid-like enthalpy h with respect to a temperature T, c_{p,LL} represents a liquid-like specific heat capacity, T_{LL,ref} represents a temperature of liquid-like reference point, h_{pb}(T) represents a function of pseudo-two-phase enthalpy h with respect to the temperature T, c_{p,pc} represents a pseudo-two-phase specific heat capacity, T_{pc} represents a pseudo-critical temperature, h_{GL}(T) represents a function of gas-like enthalpy h with respect to the temperature T, c_{p,GL} represents a gas-like specific heat capacity, T_{GL, ref} represents a temperature of gas-like reference point, and the unit of all the above temperatures is K.

The boundary temperatures Tₛ⁻ and Tₛ⁺ of the second fluid are calculated, and the heat balance equations of fluid on two sides of the gas-like region and the liquid-like region are as follows:

$$\begin{matrix}{m}_{p} ( {h}_{p}^{i n} - {h}_{p}^{+} ) = {m}_{s} ( {h}_{s}^{out} - {h}_{s}^{+} ) \\ {m}_{p} ( {h}_{p}^{i n} - {h}_{p}^{-} ) = {m}_{s} ( {h}_{s}^{out} - {h}_{s}^{-} )\end{matrix}$$

where mₚ represents a mass flow rate of the first fluid, mₛ represents a mass flow rate of the second fluid, hₚⁱⁿ represents an enthalpy value at the inlet of the first fluid, hₛ^{out} represents an enthalpy value at the outlet of the second fluid, hₚ⁺ represents an enthalpy value at a lower boundary of a pseudo-two-phase region of the first fluid, hₚ⁻ represents an enthalpy value at an upper boundary of the pseudo-two-phase region of the first fluid, hₛ⁺ represents an enthalpy value at a lower boundary of a pseudo-two-phase region of the second fluid, hₛ⁻ represents an enthalpy value at an upper boundary of the pseudo-two-phase region of the second fluid, a subscript p represents the first fluid, and a subscript s represents the second fluid.

S3, a temperature of an inner wall surface of the first fluid in the heat exchanger is calculated, and an upper boundary temperature of a pseudo-superheated condensation region is calculated during cooling the first fluid, including calculating an inlet wall temperature T_{w}ⁱⁿ, a wall temperature T_{w}⁻ at the upper boundary of the pseudo-two-phase region, a wall temperature T_{w}⁺ at the lower boundary of the pseudo-two-phase region, and an outlet wall temperature T_{w}^{out} at four axial positions corresponding to an inlet temperature Tₛⁱⁿ of the second fluid, a boundary temperature Tₛ⁻ of the second fluid, a boundary temperature Tₛ⁺ of the second fluid and an outlet temperature Tₛ^{out} of the second fluid.

Equations for calculating the upper boundary temperature Tₚ⁺⁺ of the pseudo-superheated condensation region during cooling the first fluid are as follows:

$$\frac{{Q}^{+} - {Q}^{++}}{{Q}^{+}} = \frac{{T}_{w}^{++} - {T}_{w}^{+}}{{T}_{w , in} - {T}_{w}^{+}}$$

$${Q}^{++} = {m}_{p} ( {h}_{p}^{in} - {h}_{p}^{++} )$$

where Q⁺⁺ is a heat transfer amount from an inlet to the upper boundary of the pseudo-superheated condensation region, hₚ⁺⁺ is an enthalpy value at the upper boundary of the pseudo-superheated condensation region, T_{w}⁺⁺ is a wall temperature at the upper boundary of the pseudo-superheated condensation region, T_{w}ⁱⁿ is a wall temperature at an inlet, mₚ is a mass flow rate of the first fluid, Q⁺ is a heat transfer amount from the inlet to a lower boundary of the pseudo-superheated condensation region, hₚⁱⁿ is an enthalpy value at an inlet of the first fluid, and Tw⁺ is a wall temperature at the lower boundary of the pseudo-superheated condensation region.

S4, the heat exchanger is divided into four regions on the basis of a pseudo-phase transition three-region model, and a length of the heat exchanger in each region is calculated. The specific calculation steps are as follows.

S4.1, a heat transfer coefficient Uᵢ of each region is calculated. An expression of the heat transfer coefficient is as follows:

$${U}_{i} = \frac{{Nu}_{i} {λ}_{i}}{d}$$

where Nuᵢ is calculated by empirical correlations,
d is a hydraulic diameter, λᵢ is a thermal conductivity coefficient of an iₜₕ section, and Nuᵢ is the Nusselt number of the iₜₕ section.

For the first fluid, Dang-Hihara correlation is used for cooling, and Krasnoshchekov-Protopopov correlation is used for heating; and Gnielinski correlation is used for the second fluid.

### Dang-Hihara Correlation:

$$Nu = \frac{( ξ / 8 ) ( Re - 1000 ) Pr}{1.07 + 12.7 \sqrt{ξ / 8} ( {Pr}^{2 / 3} - 1 )}$$

$$n = \{ \begin{matrix}{c}_{p} {μ}_{b} / {k}_{b} , & for {c}_{p} ⩾ {\overline{c}}_{p} \\ {\overline{c}}_{p} {μ}_{b} / {k}_{b} , & for {c}_{p} < {\overline{c}}_{p} and {μ}_{b} / {k}_{b} ⩾ {μ}_{f} / {k}_{f} \\ {\overline{c}}_{p} {μ}_{f} / {k}_{f} , & for {c}_{p} < {\overline{c}}_{p} and {μ}_{b} / {k}_{b} < {μ}_{f} / {k}_{f}\end{matrix}$$

$${\overline{c}}_{p} = \frac{{h}_{w} - {h}_{b}}{{T}_{w} - {T}_{b}}$$

$$ξ = {( 1.82 {log}_{10} ( Re ) - 1.64 )}^{- 2}$$

### Krasnoshchekov-Protopopov Correlation:

$$Nu = \frac{( ξ / 8 ) ( Re - 1000 ) Pr}{1.07 + 12.7 \sqrt{ξ / 8} ( {Pr}^{2 / 3} - 1 )} {( \frac{{ρ}_{w}}{{ρ}_{b}} )}^{0.3} {( \frac{{\overline{c}}_{p}}{{c}_{p}} )}^{n}$$

$$n = \{ \begin{matrix}0.4 , & for \frac{{T}_{w}}{{T}_{pc}} ⩽ 1 or \frac{{T}_{b}}{{T}_{pc}} ⩾ 1.2 \\ 0.4 + 0.2 ( \frac{{T}_{w}}{{T}_{pc}} - 1 ) , & for \frac{{T}_{b}}{{T}_{pc}} < 1 ⩽ \frac{{T}_{w}}{{T}_{pc}} \\ 0.4 + 0.2 ( \frac{{T}_{w}}{{T}_{pc}} - 1 ) ( 1 - 5 ( \frac{{T}_{b}}{{T}_{pc}} - 1 ) ) , & for \frac{{T}_{w}}{{T}_{pc}} ⩾ 1 and \frac{{T}_{b}}{{T}_{pc}} < 1.2\end{matrix}$$

### Gnielinski Correlation:

$$Nu = \frac{( ξ / 8 ) ( Re - 1000 ) Pr}{1.07 + 12.7 \sqrt{ξ / 8} ( {Pr}^{2 / 3} - 1 )}$$

where Nu is Nusselt number, Reis Reynolds number, Pr is Prandtl number, ξ is a friction factor, [symbol] ₚ is an average specific heat capacity (J/(kg·K)), μₚ is mainstream dynamic viscosity (Pa·s), k_{b} is a mainstream thermal conductivity coefficient (W/(m·K)), μ_{f} is boundary layer dynamic viscosity (Pa·s), k_{f} is a boundary layer thermal conductivity coefficient (W/(m·K)), T_{b} is a mainstream temperature (K), T_{w} is a wall temperature (K), h_{b} is a mainstream enthalpy value (J/kg), ρ_{w} is fluid density at wall surface (kg/m³), ρ_{b} is mainstream fluid density (kg/m³), subscript b is mainstream, and f is a boundary layer.

S4.2, the heat exchanger efficiency εᵢ of each region is determined from the inlet and outlet temperatures of hot and cold fluids of the region. An expression of the heat exchanger efficiency εᵢ is as follows:

$${ε}_{i} = ( \frac{{\overline{C}}_{p , i}}{{C}_{min , i}} ) \frac{{T}_{p , i}^{in} - {T}_{p , i}^{out}}{{T}_{p , i}^{in} - {T}_{s , i}^{in}}$$

$${\overline{C}}_{p , i} = {m}_{p} \frac{{h}_{p , i}^{out} - {h}_{p , i}^{in}}{{T}_{p , i}^{out} - {T}_{p , i}^{in}}$$

where [symbol] _{p,i} represents an average heat capacity rate of the first fluid in the iₜₕ section, T_{p,i}ⁱⁿ represents a temperature of the first fluid at an inlet of the iₜₕ section, T_{p,i}^{out} represents a temperature of the first fluid at an outlet of the iₜₕ section, mₚ represents a mass flow rate of the first fluid, T_{s,i}ⁱⁿ represents a temperature of the second fluid at an inlet of the iₜₕ section, h_{p,i}^{out} represents an enthalpy value at an outlet of the first fluid, h_{p,i}ⁱⁿ represents an enthalpy value at an inlet of the first fluid, and C_{min,i} represents the minimum heat capacity rate of the iₜₕ section.

S4.3 the length Lᵢ of the heat exchanger in the region is calculated, and an expression is as follows:

$${L}_{i} = \frac{{C}_{min , i}}{{U}_{i} P ( 1 - {R}_{C , i} )} ln \{ \frac{1 - {ε}_{i} {R}_{C , i}}{1 - {ε}_{i}} \}$$

$${R}_{C} = \frac{{C}_{min}}{{C}_{max}}$$

where R_{C} represents a hot-melt ratio, P represents a wetted perimeter, Cₘₐₓ represents the maximum heat capacity rate, ln represents a logarithmic operation, and a subscript i=I, II, IIIa, IIIb or Ia, Ib, II, III or I, II, III, representing different regions.

S5, a total length of the heat exchanger is obtained.

$${L}_{total} = \{ \begin{matrix}{L}_{I} + {L}_{II} + {L}_{IIIa} + {L}_{IIIb} , & cooling of the first fluid \\ {L}_{Ia} + {L}_{Ib} + {L}_{II} + {L}_{III} , & heating of the first fluid \\ {L}_{I} + {L}_{II} + {L}_{III} , & in the absence of {T}_{p}^{++} or {T}_{p}^{--}\end{matrix}$$

where L is the length of the heat exchanger, Lₜₒₜₐₗ represents the total length of the heat exchanger, Tₚ⁺⁺ represents the upper boundary temperature of the pseudo-superheated condensation region of the first fluid, and Tₚ⁻⁻ represents the upper boundary temperature of the pseudo-subcooled boiling region of the first fluid.

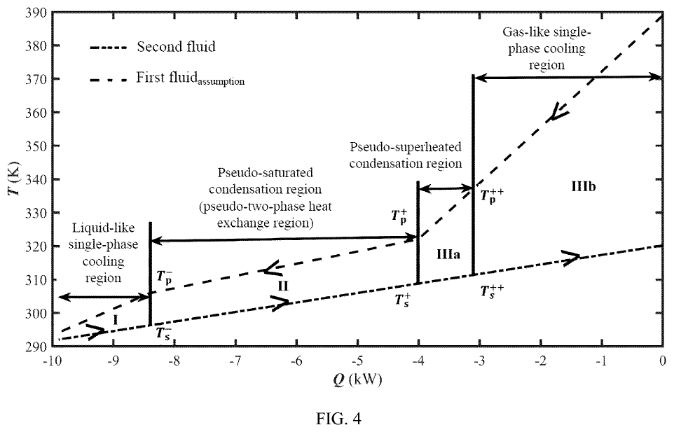

According to the above steps, a general partition situation when the method is used in a supercritical cooler is shown in FIG. 4. The design of carbon dioxide air cooler is taken as an example, a length of the air cooler is 12.9 m, an inner diameter of inner tube is 4.72 mm, an outer diameter of inner tube is 6.35 mm and an inner diameter of outer tube is 15.748 mm. Inlet and outlet parameters of fluids on two sides measured through experiments are as follows: for the first fluid, i.e., carbon dioxide, the inlet temperature is 389 K, the outlet temperature is 294 K, the pressure is 8.6 Mpa, and the mass flow rate is 0.03436 kg/s. For the second fluid, i.e., water, the inlet temperature is 292 K, the pressure is 0.1 Mpa, and the mass flow rate is 0.08409 kg/s. According to the above inlet and outlet information, the length of the air cooler is designed.

T_{LL,ref}=0.75 T_{pc} and P_{LL,ref}=P_{cr} are selected as liquid-like reference points, and T_{GL,ref}=T_{cr} and P_{GL,ref}=0 are selected as gas-like reference points. The positions of the calculated pseudo-two-phase boundaries T⁻ and T⁺ are shown in FIG. 1. Therefore, the heat exchanger is divided into: liquid-like region I, pseudo-two-phase region II and gas-like region III.

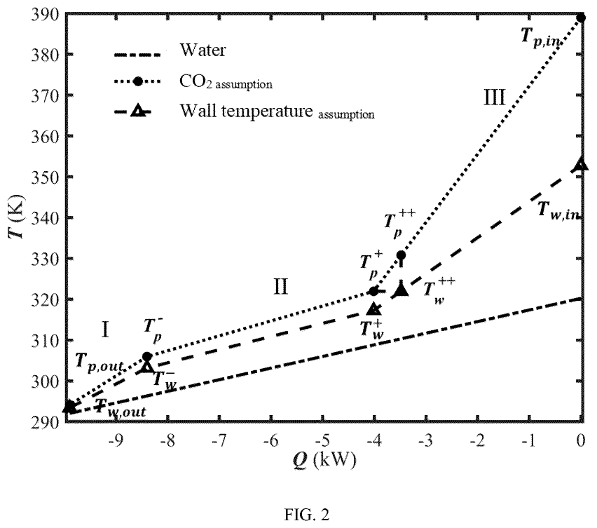

According to the method, the temperature of the tube wall has been cooled to T⁺ when the supercritical carbon dioxide is still in the region III, the thermophysical properties of the fluid around the tube wall will start to change dramatically while the thermophysical properties of the carbon dioxide still maintain a small range of linear changes, and the gas-like region can be divided based on this phenomenon. FIG. 2 shows that the hypothetical temperature distribution curve of the first fluid is obtained by T_{p,in}, Tₚ⁺, Tₚ⁻ and, T_{p,out}, and the hypothetical temperature distribution curve of the wall is obtained by T_{w,in}, T_{w}⁺, T_{w}⁻ and, T_{w,out}. When T_{w}⁺⁺=Tₚ⁺, Q⁺⁺ is calculated according to the similar triangle principle, and Tₚ⁺⁺ is obtained from Q⁺⁺ and the known mₚ. Therefore, the heat exchange process of carbon dioxide in the air cooler can be divided into four intervals: gas-like single-phase cooling region (IIIb), pseudo-superheated condensation region (IIIa), pseudo-saturated condensation region (pseudo-two-phase heat exchange region) (II) and liquid-like single-phase cooling region (I). The results are shown in FIG. 4.

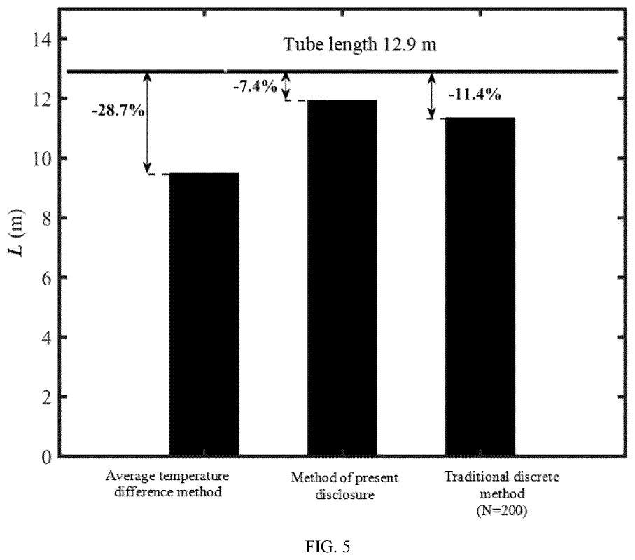

In FIG. 5, the lengths of the air cooler calculated by the traditional inlet and outlet average temperature model, by the discrete model and by the method of the present disclosure are compared, with the length in a case that the number of segments N=200 being selected for the discrete model. The results show that the average temperature difference method is not suitable for the design of supercritical heat exchanger, because it results in the largest calculation error despite of the shortest calculation time. The calculation result of the traditional discrete method is not as accurate as that of the method of the present disclosure. In addition, in this calculation example, the total time consumed by the method of the present disclosure is 0.421 s, significantly lower than 5.545 s consumed by the traditional discrete method.

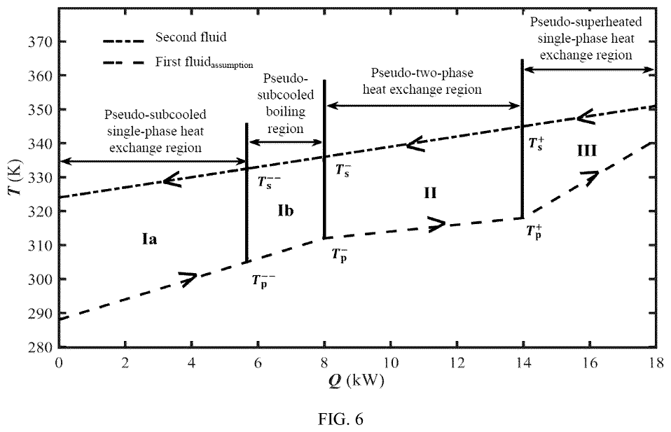

The general partition situation when the method is used in a supercritical evaporator is shown in FIG. 6. The design of carbon dioxide evaporator is taken as an example, a length of the evaporator is 2.74 m, an inner diameter of inner tube is 10.9 mm, an outer diameter of inner tube is 12.7 mm, and an inner diameter of outer tube is 16.6 mm. The inlet and outlet parameters of the fluids on two sides measured through experiments are as follows: for the first fluid, i.e., the carbon dioxide, the inlet temperature is 274 K, the outlet temperature is 336 K, the pressure is 8.6 Mpa, and the mass flow rate is 0.01833 kg/s. For the second fluid, i.e., water, the inlet temperature is 376 K, the pressure is 0.1 Mpa, and the mass flow rate is 0.19117 kg/s. According to the above inlet and outlet information, the length of the evaporator is designed.

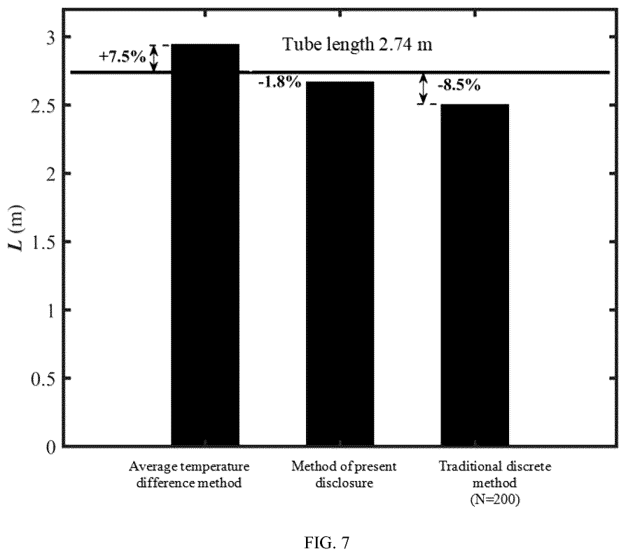

According to the method of the present disclosure, there is no Tp in this calculation example, and the heat exchange process of carbon dioxide in the evaporator is simplified into three regions: a pseudo-subcooled single-phase heat exchange region (I), a pseudo-two-phase heat exchange region (II) and a pseudo-superheated single-phase heat exchange region (III). In FIG. 7, the calculation results obtained by the traditional inlet and outlet average temperature model, by the discrete model and by the method of the present disclosure are compared, with the calculation results when N=200 being selected for the discrete model. The results show that the average temperature difference method is not suitable for the design of the supercritical heat exchanger, because it results in the largest calculation error despite of the shortest calculation time. The method of the present disclosure obtains more accurate calculation results than the traditional discrete method. In addition, the calculation time consumed by the method of the present disclosure is 0.398 s, significantly lower than 3.684 s consumed by the traditional discrete method.

While examples of the present disclosure have been illustrated and described, those ordinary skilled in the art will understand that various changes, modifications, substitutions and variations can be made to these examples without departing from the principles and spirit of the present disclosure. The scope of the present disclosure is defined by the appended claims and equivalents thereof.

1. A method for designing a supercritical heat exchanger based on pseudo-phase transition partition, comprising the following steps:
S1, inputting boundary conditions of a heat exchanger;
S2, calculating an upper boundary temperature and a lower boundary temperature of a pseudo-phase transition region;
S3, calculating a temperature of an inner wall surface of a first fluid in the heat exchanger, and determining an upper boundary temperature of a pseudo-superheated condensation region during cooling the first fluid or an upper boundary temperature of a pseudo-subcooled boiling region during heating the first fluid;
in S3, the calculating a temperature of an inner wall surface of a first fluid comprising calculating an inlet wall temperature T_{w}ⁱⁿ, a wall temperature T_{w}⁻ at an upper boundary of a pseudo-two-phase region, a wall temperature T_{w}⁺ at a lower boundary of the pseudo-two-phase region, and an outlet wall temperature T_{w}^{out} at four axial positions corresponding to an inlet temperature Tₛⁱⁿ of a second fluid, a boundary temperature Tₛ⁻ of the second fluid, a boundary temperature Tₛ⁺ of the second fluid and an outlet temperature Tₛ^{out} of the second fluid;
equations for calculating the upper boundary temperature Tₚ⁺⁺ of the pseudo-superheated condensation region during cooling the first fluid in step S3 being as follows:
$$\frac{{Q}^{+} - {Q}^{++}}{{Q}^{+}} = \frac{{T}_{w}^{++} - {T}_{w}^{+}}{{T}_{w , in} - {T}_{w}^{+}}$$
$${Q}^{++} = {m}_{p} ( {h}_{p}^{in} - {h}_{p}^{++} )$$
where Q⁺⁺ is a heat transfer amount from an inlet to an upper boundary of the pseudo-superheated condensation region, hₚ⁺⁺ is an enthalpy value at the upper boundary of the pseudo-superheated condensation region, T_{w}⁺⁺ is a wall temperature at the upper boundary of the pseudo-superheated condensation region, T_{w,in} is a wall temperature at the inlet, mₚ is a mass flow rate of the first fluid, Q⁺ is a heat transfer amount from the inlet to a lower boundary of the pseudo-superheated condensation region, hₚⁱⁿ is an enthalpy value at an inlet of the first fluid, and T_{w}⁺ is a wall temperature at the lower boundary of the pseudo-superheated condensation region;
S4, dividing the heat exchanger into four regions on the basis of a pseudo-phase transition three-region model, and calculating a length of the heat exchanger in each region;
in S4, steps of the calculating a length of the heat exchanger in each region being as follows:
S4.1, calculating a heat transfer coefficient Uᵢ of each region;
an expression of the heat transfer coefficient Uᵢ in S4.1 being as follows:
$${U}_{i} = \frac{{Nu}_{i} {λ}_{i}}{d}$$
where Nuᵢ is calculated by empirical correlations,
d is a hydraulic diameter, λᵢ is a thermal conductivity coefficient of an iₜₕ section, and Nuᵢ is the Nusselt number of the iₜₕ section;
S4.2, determining a heat exchanger efficiency εᵢ of each region from inlet and outlet temperatures of hot and cold fluids of each region;
an expression of the heat exchanger efficiency εᵢ in S4.2 being as follows:
$${ε}_{i} = ( \frac{{\overline{C}}_{p , i}}{{C}_{min , i}} ) \frac{{T}_{p , i}^{in} - {T}_{p , i}^{out}}{{T}_{p , i}^{in} - {T}_{s , i}^{in}}$$
$${\overline{C}}_{p , i} = {m}_{p} \frac{{h}_{p , i}^{out} - {h}_{p , i}^{in}}{{T}_{p , i}^{out} - {T}_{p , i}^{in}}$$
where [symbol] _{p,i} represents an average heat capacity rate of the first fluid in the iₜₕ section, T_{p,i}ⁱⁿ represents a temperature of the first fluid at an inlet of the iₜₕ section, T_{p,i}^{out} represents a temperature of the first fluid at an outlet of the iₜₕ section, mₚ represents a mass flow rate of the first fluid, T_{s,i}ⁱⁿ represents a temperature of the second fluid at an inlet of the iₜₕ section, h_{p,i}^{out} represents an enthalpy value at an outlet of the first fluid, h_{p,i}ⁱⁿ represents an enthalpy value at the inlet of the first fluid, and C_{min,i} represents the minimum heat capacity rate of the iₜₕ section; and an expression of the length Lᵢ of the heat exchanger in the region being as follows:
$${L}_{i} = \frac{{C}_{min , i}}{{U}_{i} P ( 1 - {R}_{C , i} )} ln \{ \frac{1 - {ε}_{i} {R}_{C , i}}{1 - {ε}_{i}} \}$$
$${R}_{C} = \frac{{C}_{min}}{{C}_{max}}$$
where R_{C} represents a hot-melt ratio, P represents a wetted perimeter, Cₘₐₓ represents the maximum heat capacity rate, ln represents a logarithmic operation, and a subscript i=I, II, IIIa, IIIb or Ia, Ib, II, III or I, II, III, representing different regions; and
S4.3, calculating the length Lᵢ of the heat exchanger in the region; and
S5, obtaining a total length of the heat exchanger;
an expression of the total length of the heat exchanger being as follows:
$${L}_{total} = \{ \begin{matrix}{L}_{I} + {L}_{II} + {L}_{IIIa} + {L}_{IIIb} , & cooling of the first fluid \\ {L}_{Ia} + {L}_{Ib} + {L}_{II} + {L}_{III} , & heating of the first fluid \\ {L}_{I} + {L}_{II} + {L}_{III} , & in the absence of {T}_{p}^{++} or {T}_{p}^{--}\end{matrix}$$
where L is the length of the heat exchanger, Lₜₒₜₐₗ represents the total length of the heat exchanger, Tₚ⁺⁺ represents the upper boundary temperature of the pseudo-superheated condensation region of the first fluid, and Tₚ⁻⁻ represents the upper boundary temperature of the pseudo-subcooled boiling region of the first fluid.

2. The method for designing a supercritical heat exchanger based on pseudo-phase transition partition according to claim 1, wherein the boundary conditions in S1 comprise boundary conditions and thermophysical information of the first fluid and the second fluid, the first fluid is supercritical fluid, and the second fluid is ordinary fluid; and the boundary conditions comprise mass flow rate, inlet and outlet temperatures, pressure, inner diameter and wall thickness of inner tube and inner diameter of outer tube of a casing, and the thermophysical information comprises dynamic viscosity, enthalpy, specific heat capacity and Prandtl number.

3. The method for designing a supercritical heat exchanger based on pseudo-phase transition partition according to claim 1, wherein the boundary temperature of the pseudo-phase transition region in S2 comprises boundary temperatures Tₚ⁻ and Tₚ⁺ of the first fluid and boundary temperatures Tₛ⁻ and Tₛ⁺ of the second fluid.

4. The method for designing a supercritical heat exchanger based on pseudo-phase transition partition according to claim 3, wherein the boundary temperatures Tₚ⁻ and Tₚ⁺ of the first fluid are calculated, and expressions for solving a gas-like region, the pseudo-two-phase region and a liquid-like region in parallel are as follows:
$${h}_{LL} ( T ) = {c}_{p , LL} ( T - {T}_{LL , ref} ) + h ( {T}_{LL , ref} )$$
$${h}_{pb} ( T ) = {c}_{p , pc} ( T - {T}_{pc} ) + h ( {T}_{pc} )$$
$${h}_{GL} ( T ) = {c}_{p , GL} ( T - {T}_{GL , ref} ) + h ( {T}_{GL , ref} )$$
where h_{LL}(T) represents a function of a liquid-like enthalpy h with respect to a temperature T, c_{p,LL} represents a liquid-like specific heat capacity, T_{LL,ref} represents a temperature of liquid-like reference point, h_{pb}(T) represents a function of pseudo-two-phase enthalpy h with respect to the temperature T, c_{p,pc} represents a pseudo-two-phase specific heat capacity, T_{pc} represents a pseudo-critical temperature, h_{GL}(T) represents a function of gas-like enthalpy h with respect to the temperature T, c_{p,GL} represents a gas-like specific heat capacity, T_{GL,ref} represents a temperature of gas-like reference point, and the unit of all the above temperatures is K.

5. The method for designing a supercritical heat exchanger based on pseudo-phase transition partition according to claim 3, wherein the boundary temperatures Tₛ⁻ and Tₛ⁺ of the second fluid are calculated, and heat balance equations of the fluid on two sides of the gas-like region and the liquid-like region are as follows:
$${m}_{p} ( {h}_{p}^{in} - {h}_{p}^{+} ) = {m}_{s} ( {h}_{s}^{out} - {h}_{s}^{+} )$$
$${m}_{p} ( {h}_{p}^{in} - {h}_{p}^{-} ) = {m}_{s} ( {h}_{s}^{out} - {h}_{s}^{-} )$$
where mₚ represents a mass flow rate of the first fluid, mₛ represents a mass flow rate of the second fluid, hₚⁱⁿ represents an enthalpy value at the inlet of the first fluid, hₛ^{out} represents an enthalpy value at the outlet of the second fluid, hₚ⁺ represents an enthalpy value at a lower boundary of a pseudo-two-phase region of the first fluid, hₚ⁻ represents an enthalpy value at an upper boundary of the pseudo-two-phase region of the first fluid, hₛ⁺ represents an enthalpy value at a lower boundary of a pseudo-two-phase region of the second fluid, hₛ⁻ represents an enthalpy value at an upper boundary of the pseudo-two-phase region of the second fluid, a subscript p represents the first fluid, and a subscript s represents the second fluid.
